(19) United States
(12) Patent Application Publication
(10) Pub. No.: US 2012/0185824 A1
(43) Pub. Date: Jul. 19, 2012

(54) MECHANISM FOR DYNAMICALLY RESOLVING POLYMORPHIC TYPE DEPENDENCIES BETWEEN PARALLEL HETEROGENOUS RUN-TIME ENVIRONMENTS

(75) Inventors: John Sadler, Pinner (GB); Christopher Young, London (GB); Piers Lomax, Hitchin (GB); Jeff Hunter, Dorking (GB)

(73) Assignee: British Broadcasting Corporation, London (GB)

(21) Appl. No.: 13/322,698

(22) PCT Filed: May 28, 2010
(86) PCT No.: PCT/GB2010/001058

§ 371 Date: Mar. 30, 2012

(30) Foreign Application Priority Data
May 28, 2009 (GB) 0909202.4

(51) Int. Cl. G06F 9/44

(52) U.S. Cl. 717/120

(57) ABSTRACT

A mechanism for dynamically resolving polymorphic type dependencies between parallel heterogenous run-time environments is provided. The mechanism comprises a registry of class types for software objects, in which each class type is linked to a hierarchy of bindings rooted at the binding for that class type with descendent bindings in the hierarchy relating to more specific sub-classes. At run-time a pointer to an object is received, and the received static type of that pointer can be looked up in the registry to determine the location in the hierarchy of bindings at which to make an initial query for the most specific sub-class compatible with the dynamic type of the object. Subsequently, beginning at the determined location in the hierarchy of bindings, the most specific sub-class compatible with the dynamic type of the object is determined, and a run-time binding based on the most specific sub-class identified can be selected.

The invention relates to a mechanism for dynamically resolving polymorphic object types in an object oriented computer environment, consisting of multiple run-time environments each potentially based on a different programming language.

An object oriented computer environment is one in which a multitude of software components, which shall be referred to generally here as software objects or just objects, are provided by one or more parties to perform particular tasks. The characteristics and capabilities of an object are defined by one or more classes, that set out the properties and methods supported by the object, as well as any method parameters that are required as input or returned as output. Each class therefore defines a type of object that can be created at run-time.

An object may belong to more than one class, a base class that defines its characteristics in a generalised way, and further sub-classes setting out characteristics that provide more and more specialised or tailored functionality. This utilises a property of object oriented programming languages known as inheritance, by which an object of a specialised class inherits the characteristics of the classes in the class hierarchy above. The existence of different sub-classes, known as derived classes, in a hierarchy of classes also gives rise to a property known as polymorphism, by which an object of the same general type is available in further variations or sub-types. At run-time, when objects are dynamically created in order to carry out program functionality, it is not always possible to know which sub-class of object will be required, and which object will be created. To deal with this, polymorphism allows all sub-classes of objects to be referenced by a pointer the more general class to which they belong.

While polymorphism allows specialised objects to be used with flexibility, as and when they are needed, there are occasions when not being able to resolve to the particular sub-class is problematic, such as when particular functionality provide by the object belonging to the sub-class is required. In this case, if a function belonging to one sub-class is requested of an object belonging to a separate sub-class, the program may fail. Providing all of the functionality in the more general class definition, defeats the object of polymorphic structures, and results in inefficient use of memory space.

Whilst object oriented hierarchies as described above are well understood and implemented in single run-time environments, problems are presented when a selection of the hierarchy in one run-time environment needs to be accessed by a parallel hierarchy in another run-time environment.

We have therefore appreciated that there is a need for a mechanism for resolving the polymorphic type of an object at run-time so that the optimal functionality can be provided in an environment comprising parallel heterogeneous run-time environments.

### SUMMARY OF THE INVENTION

The invention is defined in the independent claims to which reference should now be made. Advantageous features are set forth in the dependent claims.

In a preferred aspect the invention provides a computer implemented method for providing run-time bindings between multiple heterogeneous run-time environments in a computing device in which software objects having polymorphic types are employed, the bindings providing code for manipulating the attributes of, and invoking the methods of, software objects according to their dynamic type in one run-time environment from another, the method comprising: a) providing a registry of class types for software objects, in which each class type is linked to a hierarchy of bindings rooted at the binding for that class type with descendent bindings in the hierarchy relating to more specific sub-classes; b) receiving at run-time a pointer to an object, and looking-up the received static type of that pointer in the registry to determine the location in the hierarchy of bindings at which to make an initial query for the most specific sub-class compatible with the dynamic type of the object; c) beginning at the location in the hierarchy of bindings determined in step b), identifying the most specific sub-class by determining which specific sub-class is compatible with the dynamic type of the object; d) selecting a run-time binding based on the most specific sub-class identified in step c).

In one embodiment, determining whether a sub-class is compatible with the dynamic type of the object comprises attempting to downcast the object pointer to a pointer of the sub-class type.

In one embodiment, once a binding has been identified in step d) an entry is added to the registry linking the dynamic type with the identified run-time binding.

In a second aspect, the invention provides a computer implemented method of providing run-time bindings in a computer device, in which first software objects provided in a first run-time environment are to be bound at run-time to second software objects provided in a second run-time environment, and wherein at least the first software objects are polymorphic with respect to their run-time data types, the run-time bindings providing code for manipulating the attributes of, and invoking the methods of, software objects according to their dynamic type, the method comprising: a) receiving definitions for the methods and attributes respectively exposed by the first and second software objects; b) generating binding source code based on the received definitions and a rule base; c) receiving mapping code defining, for a plurality of class types, a hierarchy of bindings rooted at the binding for a first class type with descendent bindings in the hierarchy relating to more specific sub-classes; d) compiling the mapping code and binding source code to produce a run-time binding library and a run-time binding support registry; wherein the run-time binding support registry lists for each object class type a hierarchy of bindings rooted at the binding for that class type with descendent bindings in the hierarchy relating to more specific sub-classes, and wherein the run-time binding support registry can be queried at run-time based on the received static type of an object pointer to determine the location in the hierarchy of bindings at which to make an initial query for the most specific sub-class compatible with the dynamic type of the object; and at run-time, selecting a run-time binding based on the most specific sub-class derived class identified as compatible with the dynamic type of the object.

Corresponding computer program products and apparatus, such as a suitable computer data structure, are also contemplated.

### BRIEF DESCRIPTION OF THE DRAWINGS

Examples of the invention will now be described in more detail by way of example, and with reference to the drawings in which:

FIG. 1 is an illustration of an example hybrid digital video receiver consisting of multiple run-time environments, operating in parallel, in which the invention can be employed;

FIG. 2 is an example of a system for generating the code necessary for an updatable dynamic environment;

FIG. 3 is an illustration of an example binding that exposes a C++ interface class in the JavaScript programming language used in Web Browsers;

FIG. 4 is an illustration of interfaces of a simple C++ Application Program Interface and the relationship of these interfaces to the bindings that are used to make the interfaces available in a target language such as JavaScript;

FIG. 5 is an illustration of a preferred example of a mechanism for resolving the polymorphic type of an object at run-time; and

FIG. 6 is a UML sequence diagram illustrating the operation of the invention.

### DESCRIPTION OF EXAMPLE IMPLEMENTATION

To aid understanding, a brief glossary is provided below for aspects of terminology used in this description. This is not intended to limit the scope of the invention in any way, and is merely intended as an aid for the reader.

Object—In object oriented programming languages, an object is a logical entity that possesses characteristics representing its role in the run-time environment. Characteristics include functions and methods that can be called by other objects, as well as properties such as variables and constants that define the state of the object.

Method—A method is a subroutine that is exclusively associated either with a class (called class methods or static methods) or with an object (called instance methods).

Run-time Environment—Provides software services for processes or programs while a computer is running. It may pertain to the operating system itself, or the software that runs on top of it. Example Run-time Environments include Web Browsers and Broadcast MHEG Engines. Parallel heterogeneous run-time environments refers to the existence of a plurality of run-time environments existing in parallel and implemented in potentially different computer languages.

Type—All objects belong to a type. A type is a classification of an object according to the particular properties it possesses. Further, Typeld generally refers to the type of an object, or to function provided by Run-time Type Identification (RTTI) for returning the type of an object to the requestor.

Class—A class defines a type in terms of the characteristics, functions and variables, that distinguish that type from other types. At run-time, objects with the desired types are created from the corresponding classes.

Superclass—A class from which other classes are derived. A superclass is also called a parent class. The classes that are derived from a superclass are known as child classes, derived classes, or subclasses.

Base Class—a base class is a class that has no super class, and is therefore at the base of the tree of subclasses.

Inheritance—Inheritance allows objects to be classified into subclasses, according to different levels of abstraction. Without inheritance and hierarchical classifications, each type of object would require a class to explicitly define all of its characteristics. Inheritance allows sub-classes to define only those characteristics that make an object of that class sub-unique within a more generalised class.

Run-time—Refers to the final state of the computer processor running a compiled program. In this state, objects are created and destroyed as required to carry out requested roles and functions. This state is also referred to as the run-time environment.

Compile Time—Refers to the instant at which the source code defining any objects and run-time environment constraints is compiled. Compile time types are those that that are known to exist at compile time, in comparison with types that are created at run-time dynamically.

Static Types—A programming language is said to use static typing when type checking is performed during compile-time as opposed to run-time.

Dynamic Types—A programming language is said to be dynamically typed, or just ‘dynamic’, when the majority of its type checking is performed at run-time as opposed to at compile-time.

Interfaces—An interface is an external abstraction of the functions provided by a class, and therefore by objects implementing that class. While the functions themselves are internal to the object, the interface is public allowing other objects to access the implanting object's functionality. Interfaces can be specified in advance of implementation by any particular object, to allow different third parties to develop object to fulfil the interface.

Polymorphism—Refers to the ability of an object or function to belong to more than one type or class. In object-oriented programming, polymorphism allows a name to denote instances of several different classes, providing they are related by a common super class. This is generally supported by inheritance (see above), but may also be implemented by function and method overloading.

Virtual Function—a virtual function or virtual method is one whose behaviour can be overridden within an inheriting class by a function with the same signature.

Function Overloading or Method Overloading—is a form of polymorphism and refers to the situation in which two functions have the same name but are distinguishable from one another by the parameters declared by the functions. Overloading allows a common set of functions to be accessed by the same name. Overloading is performed at compile time, and the compiler must therefore select the specific function for the particular circumstances by means of the type of the parameters.

Casting—Refers to changing an entity of one data type into another, and in object-oriented programming languages allows programs to treat objects of one type as objects of one of their ancestor types. This can simplify interactions between objects.

Downcasting—is the action of casting a reference of a base class to one of its derived classes.

Dynamic Casting—refers to the run-time action of performing a cast to verify the validity of a cast. If the cast cannot be made, then the cast fails and the expression evaluates to null. Dynamic casting can be used to perform casts on polymorphic types, that is those that are defined by polymorphic classes containing virtual functions. Dynamic cast can return a pointer to a derived object given a pointer to a polymorphic base class. If the object pointed to is not an object of the base class or of a derived class, then a null value is returned.

Bindings—code specific to a Target Run-time Environment that facilitates integration between any implementation of the described API, and the target Run-time Environment.

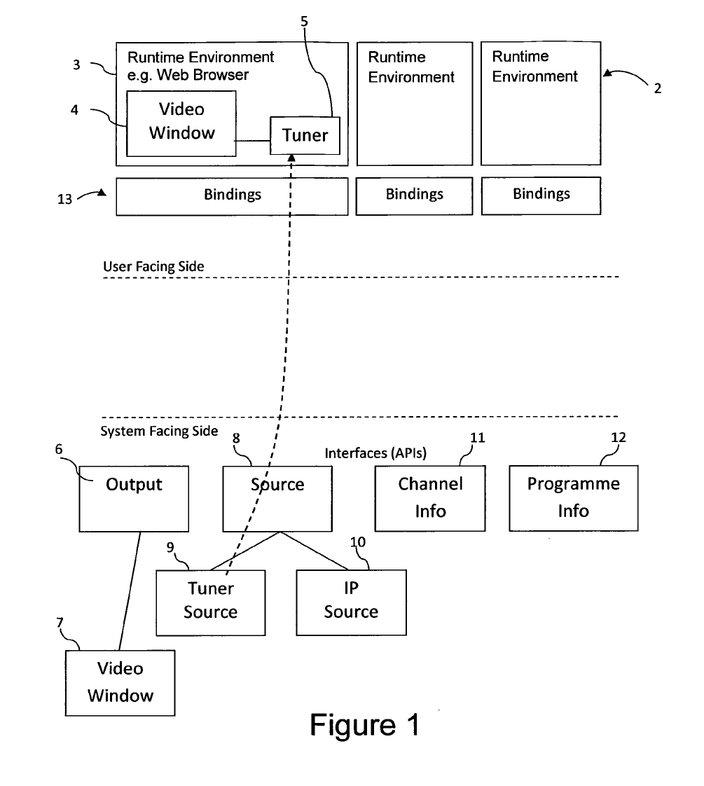

With reference to FIG. 1, an example implementation of the invention will now be described in the context of a hybrid digital video receiver, such as a Set Top Box. In this example, software components provide user-facing, front-end functionality such as Video Windows, as well as system-facing, back-end functionality such as video sources. As shown in FIG. 1, the user facing domain consists of a number of Run-time Environments 2, such as a Web Browser 3, each of which can potentially use its own specific programming language such as JavaScript, Python or MHEG-5. Within these Run-time Environments functionality such as video playback and channel selection can be provided to the user, for example by means of a Video Window 4 and Tuner 5.

System functionality provides the resources and functionality required to facilitate the functionality presented to the end user by these Run-time Environments. System functionality may be written in a language like C++ for example.

The characteristics, tolerances and requirements of the user-facing and system-facing domains are sufficiently different to require that they accommodate functionality that is written in different programming languages, and that require different presentations of data according to the programming language and the conceptual basis behind it. At the same time data has to pass between the different software components in order for the receiver to be operable and for a user to have access to a Broadcaster's audio or video content.

This problem of compatibility is often solved with Application Program Interfaces (APIs), namely public specifications of functionality that are implemented by software objects. Implementations provided by third parties of the interface can then be assured to operate in a specified manner regardless of their internal design.

In FIG. 1, it is assumed that a number of interfaces have been provided at the system facing-side, namely Media Output 6, Video Window 7, Source 8, Tuner Source 9 , IP Source 10, Channel Info 11 and Programme Info 12. Receiver manufacturers can then make objects available that fulfil these criteria.

However, the user-facing Run-time Environments must include functionality that is capable of accessing the broadcaster content via the System APIs. Additionally, the data received from the System must be capable of being presented by the user-facing Run-time Environments. Although, it is in the interest of broadcasters to provide the data in a compatible format, this is not always straightforward due to the number of different user-facing Run-time Environments available. Further, developers of user-facing Run-time Environments are not likely to cooperate to the extent that respective viewing technology interfaces can be defined.

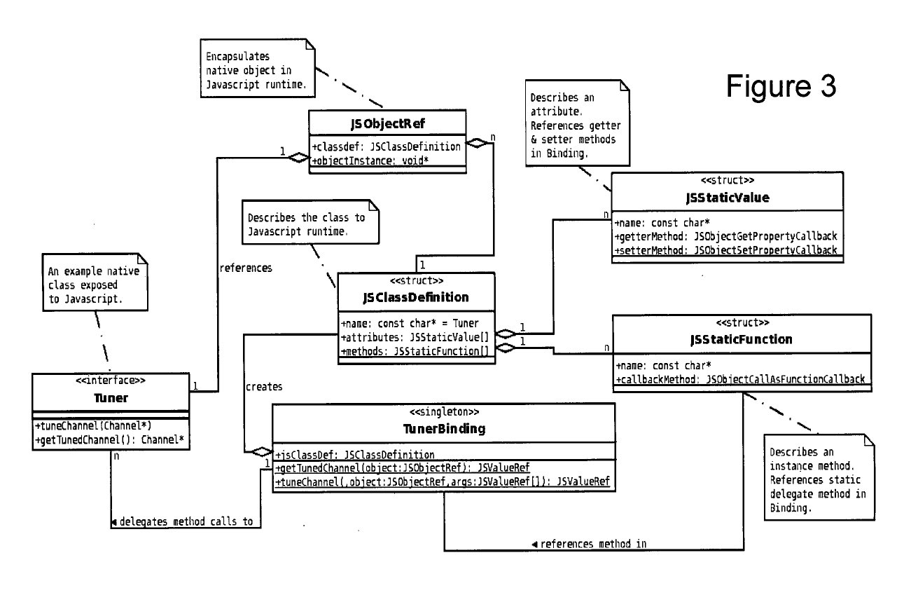

This problem is solved by using bindings 13, namely a piece of code that bridges the logical disconnection or gap between an interface at the system facing side and the user-facing Run-time Environments implemented in a target language. Note that in object oriented programming language, the term Dynamic Binding is often used to refer to the determination at run-time of an object's type, so that the correct form of a method specified in a more abstract form of the type can be called. Here, the term Binding is used to refer to the wiring between the front end and back end that is required for data, and function calls to be properly passed from the front end to the back end. An example of Bindings is described below in more detail and with reference to FIG. 3.

Bindings therefore act to translate between the objects implementing the system level interfaces, and the user-facing run-time environments, and a binding therefore needs to exist for each combination of system facing side object type and the corresponding object in the user facing side target language. However, as noted above as objects can be polymorphic, it is not always possible to determine until run-time the specific type of the object for which the binding is required. For example, in the broadcasting environment discussed, a static type for an object might be a Source (of video data) or a VideoWindow (for presenting data to a user). These types are static in the sense that at run-time objects of the Source and VideoWindows types will present well defined interfaces. Implementations of Source might be Tuner or IP Source representing objects that encode broadcast video data sources and Internet Protocol video sources respectively. These types can be considered dynamic, as at compile time the type of the source object used in the target language will not be known. It will only be possible to determine the type at run-time when objects of that type are instantiated in the run-time environment.

A VideoWindow object might have an association with a Source object, as the source of the video data it is to display. Objects belonging to the Tuner class and to the IP Source class both inherit the characteristics of the generic Source Class. The VideoWindow therefore has a polymorphic relationship with Source in that it can uses a specific type of Source, such as a Tuner or and IP Source, but its getSource( ) accessor method just returns a pointer to a generic Source. This can be problematic if a further object in the user-facing run-time environment wishes to call methods provided in a specific sub-class of Source, but cannot determine if the actual Source object encapsulated by the VideoWindow belongs to that sub-class.

For example a front end user interface using a VideoWindow to display video data, may receive an input from a user requesting broadcast video data from another video channel. In this event, the front end may instruct the VideoWindow to issue a “select new channel” instruction to its video Source. If the Source of the VideoWindow is a Tuner Source, the VideoWindow and Tuner Source will be able to comply with the request and offer another broadcast channel for viewing. If the VideoWindow Source is an IP Source however the instruction to retune is unlikely to be supported by a suitable method of the IP Source object, and the request will fail. In the same way, the IP Source may also provide methods and functionality such as changes to Resolution of the received data, which may not be supported by a Tuner Source.

As noted above, as the VideoWindow is an entity that exists at the user facing side, and the objects implementing the Source, Tuner Source and IP Source classes that exist at the system facing side, a binding will be required for the VideoWindow to utilise the Source objects efficiently. Not being able to determine the specific sub-class of the Source class at run-time, means that the correct binding cannot be chosen and communication will fail.

Such problems could be resolved by carefully specifying the nature of all possible associations between objects in advance, by requiring VideoWindow objects to make available methods to provide a particular kind of Source on request, or to require all specific types of object such as Tuners and IP Sources to provide largely interchangeable functionality. However, hard wiring the system in advance in this way defeats the flexibility of the software object model approach, making it difficult to add new functionality over time as the system evolves. It also creates a large programming burden on developers who must incorporate code into objects that is not related to the functionality of the object itself. It additionally requires inefficient use of memory space either to store objects that themselves contain unnecessary code, or to store any further objects that may be required at run-time to perform requested tasks.

The inventors have therefore appreciated that there is a need to provide a mechanism for resolving the type of polymorphic objects at run-time in scenarios where the dynamic type of an object is opaque to entities contained in other run-time environments.

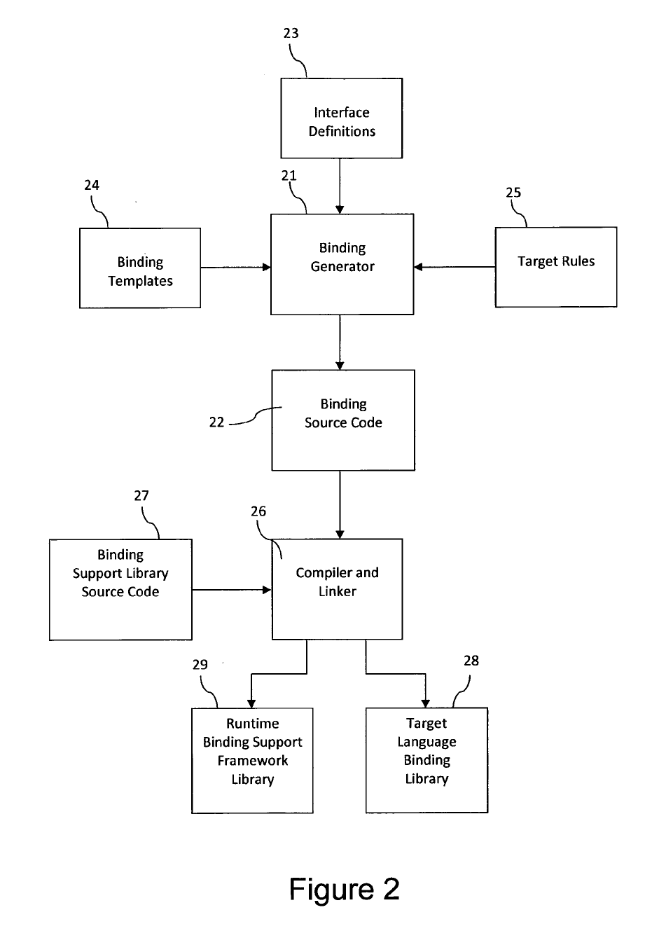

First reference will now be made to FIG. 2, which illustrates a system for generating the necessary bindings to maintain connectivity at run-time between objects implemented in different languages and environments, such as those shown in FIG. 1. It will be appreciated that at run-time these entities will necessarily exist either in the memory of the set top box or client computer displaying video content, or partly at accessible locations on a broadcast network, such as a server. The logical division of FIG. 1 into a user facing side and a system facing side describes the purpose and visibility of these domains. It should also be noted that such a division allows different implementation technologies to be used for the user facing and system components depending on the fitness for purpose of these technologies.

The system comprises a binding generator 21 for generating the binding source code 22 needed to connect objects at run-time. The binding generator receives as an input interface definitions 23 defining any methods and parameters set out in the system facing side interfaces. The interface definition can be provided in C++ header file setting out the relevant class definitions or in any other Interface Definition Language (IDL).

The binding generator also receives as an input a BindingTemplate 24. This provides a definition of the interfaces made available by the front end applications for general access to multimedia data, such as webpages, audio video content and so on, and may be written in any suitable computer language for presentation to the binding generator 21. The BindingTemplates 24 may be generated by a human investigator familiar with the back end interfaces, either by inspection of the documentation frequently provided by application developers to describe the interfaces provided by the front end applications, and, or as well as by inspection of the applications and application code themselves.

The Interface definitions 23 and Binding Templates 24 therefore define the start and end points in a possible channel of communication between the user facing side and the system facing side functionality. At any time, the particular binding source code required will depend on the target language functionality at the user facing side, and the target object in use at the system facing side.

In general, the target languages used to code the user facing side functionality shown in the top portion of FIG. 1, will have their own type systems which, whilst bearing similarities, differ from those of C++ say, which as noted above may be used at the system facing side. For example, Javascript defines a Number type, but there is no differentiation into specific numeric types such as int, long, double, and float types found in C++. The C or C++ plug-in Software Development Kits or SDKs for the target language run-time (such as the WebKit's Web Browser JavascriptCore library) provide opaque structures that encapsulate variables of different types in the target run-time, and provide functions for converting values between these representations and their native or system side types. They may also provide a means of describing the composite native types, (such as classes), in terms of their properties and/or methods.

The JavascriptCore library, for example, provides a JSValueRef type, and provides methods like: JSValueMakeString( ) and JSValueMakeNumber( ) which are used to convert native C++ string and number types to JSValueRef for exposure into the Javascript run-time.

For objects, there is a JSObjectMake( ) method which can be used to encapsulate native C++ objects. However this method requires a description of the object type (its class), which is provided by the Binding for that class. As noted in general terms above, the Binding describes the attributes and methods available on objects of that class, and provides callback methods that provide the hook for the Javascript run-time to manipulate attributes and invoke methods on native objects of that class. The exact form of such a Binding varies, depending on the target language, but taking the Javascript example, a conceptual model is shown in FIG. 3.

The generated Binding code, in FIG. 3 the Tuner Binding, must call the appropriate conversion functions to convert exposed values to the target types (e.g. exposing a method return value), and vice-versa for values received from the target run-time (e.g. receiving method parameters). This implies that there must exist a mapping between each supported C++ type, and its equivalent type in the target language. Due to C++'s rich type system, and the presence of pointers, references, smart pointers, typedefs and other commonly-used features, a naive mapping performed in the code generator could quickly become rather awkward, and complicate the generator code considerably.

The implemented solution solves the problem by utilising C++'s method overloading feature, shifting the problem onto the C++ compiler. For each target language, a so-called WrapFactory C++ class is created which provides two methods: wrap( ) and unwrap( ).

The wrap( ) method takes a value of some native type and converts it into a value compatible with the target. The unwrap( ) method performs the reverse process. There are multiple definitions of each of these methods, one for each type that is to be supported. For example, the WebKit JSCore implementation declares methods that look like this:
static JSValueRef wrap(JSContextRef context, const std::string& val);
static JSValueRef wrap(JSContextRef context, int val);
static JSValueRef wrap(JSContextRef context, bool val); and:
static void unwrap(JSContextRef context, JSValueRef jsValueRef, std::string& unwrapped);
static void unwrap(JSContextRef context, JSValueRef jsValueRef, int& unwrapped);
static void unwrap(JSContextRef context, JSValueRef jsValueRef, bool& unwrapped);

Where JSValueRef is an opaque C structure defined by WebKit's Javascript run-time that holds some value.

The implementation of each method performs the type-specific steps needed to perform the conversion. So binding templates can operate by delegating type conversions to the WrapFactory, like this:
${field. type) unwrapped;
JSCoreWrapFactoty::unwrap(ctx, jsValueRef, unwrapped);

With reference again to FIG. 2, the interface descriptions 23 and BindingTemplates 24 are input into the Binding generator 21, which parses the inputs based on Target Rules 25. Providing the data input into the generator conforms with predetermined criteria regarding its expression and syntax, the Binding Source Code 22 that defines the Bindings can be generated in known manner. The Target Rules specify for each target language and interface definition language how to interpret the input information.

The Binding generator therefore outputs Binding Source Code 22 that includes code to generate any Bindings likely to be needed at run-time for the possible combinations of target language functionality and interface functionality known about and described in the input definitions 23 and 24. If new functionality is added to either the front or back end, descriptions for the new functionality can be provided to the generator so that new Binding source code 22 required can be generated.

As explained above for the case of Tuner and IP Sources, although Bindings exist for each aspect of functionality, it may be the case that at run-time there is not enough information for the appropriate Binding to be identified and made available. In the worst case, this may result in requested functionality not be available, and the Broadcast system crashing, while in other cases it may simply result in suboptimal operation.

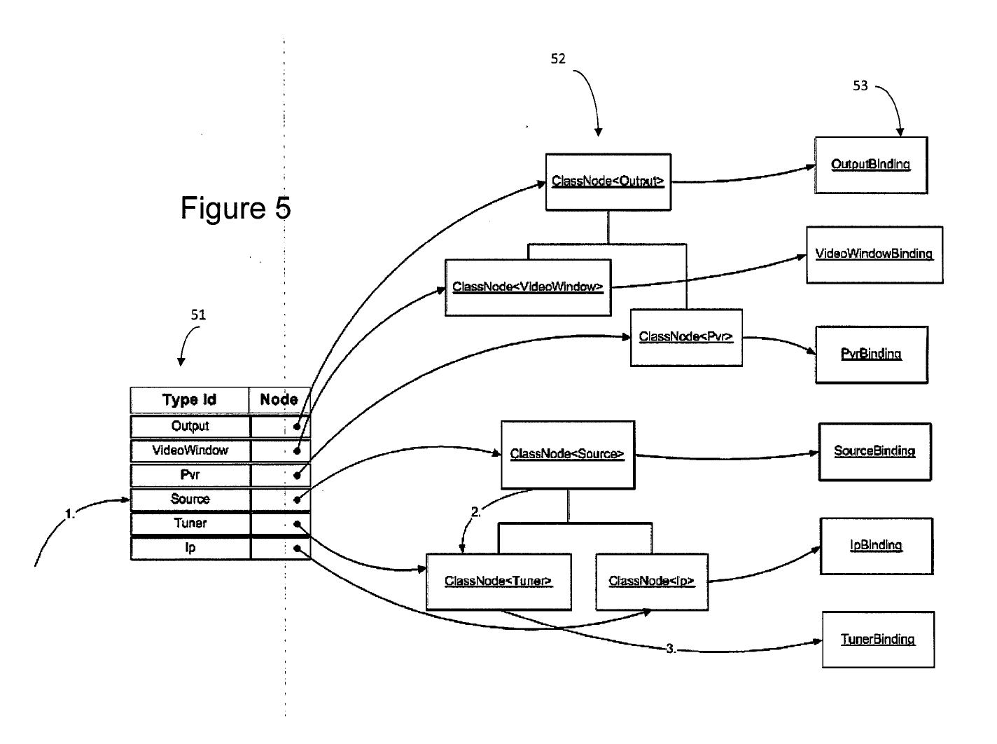

Additionally, compiler 26 therefore receives Binding Support Library Source Code 28. This code defines the mechanism illustrated later with reference to FIG. 5, and provides the mapping registry between one or more class types and the corresponding bindings. The code defining the mapping mechanism contains the necessary control logic to both define the hierarchy of bindings illustrated in FIG. 5, and the control logic to navigate the tree hierarchy. In further embodiments, it contains the code to update the mapping registry.

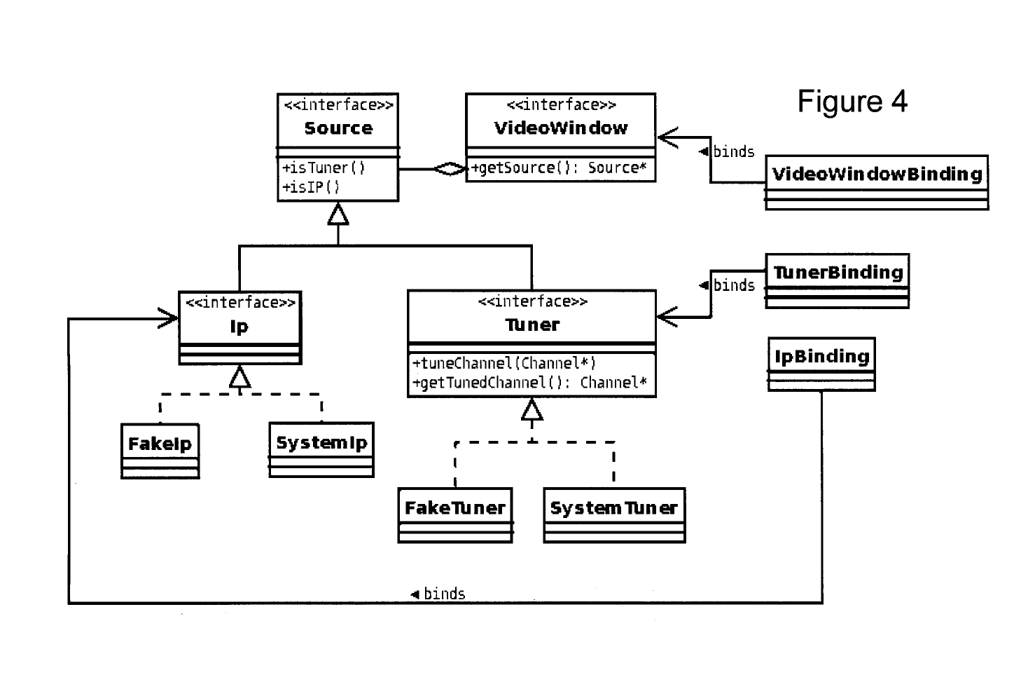

The Binding Source Code 22 and Binding Support Library Source Code 28 are then input into Compiler and Linker 26, resulting in the generation of the Target Language Binding Library 28 containing the compile code for instantiating at run-time the necessary Bindings, and the Run-time Binding Support Framework Library 29, which allows for Run-time Selection of Target Bindings for Polymorphic Types. With reference to FIG. 4, the issue of resolving polymorphic types will now be described in more detail.

It is common for object-orientated APIs to define inter-relationships between custom types (classes), and for these relationships to be polymorphic. Considering the simplified API-fragment, expressed in the UML diagram of FIG. 4, four example interfaces are illustrated, namely: Source, IP, Tuner, & VideoWindow. These are expressed as abstract classes in C++, and as is known in the art describe the contract that any implementation of the respective interfaces must fulfil. An arbitrary number of implementations may exist for any interface, but all implementations must fulfil the interface contract.

The diagram shows two example concrete implementations for both IP and Tuner, namely: the FakeIP and SystemIP, and FakeTuner and SystemTuner interfaces. It is for this reason that it is preferred to generate Bindings for the interfaces, rather than for specific implementations, as doing this allows different implementations to be substituted without the need to re-generate and recompile to target bindings. The diagram shows three target bindings, namely VideoWindowBinding, TunerBinding, and IPBinding.

Both Tuner and IP are specialisations of the Source interface, and VideoWindow has a polymorphic relationship with Source: that is it uses a specific type of Source, but the getSource( ) accessor method just returns a pointer to a Source. The accessor method is configured in this way to take maximum advantage of the availability of polymorphic types.

Now consider what happens at run-time when getSource( ) is invoked on a VideoWindow object from the user-facing Run-time environment via VideoWindow Binding, and the actual source object happens to be an implementation of the sub class Tuner, for example an implementation called SystemTuner. The method signature for getSource( ) only indicates the static type of the return value: Source, but in order for the target in the user-facing run-time environment to get full access to the actual tuner implementation, it must construct a Target Wrapper for the returned value using the TunerBinding, since Tuner is the most specific interface implemented by the dynamic type of the object: SystemTuner.

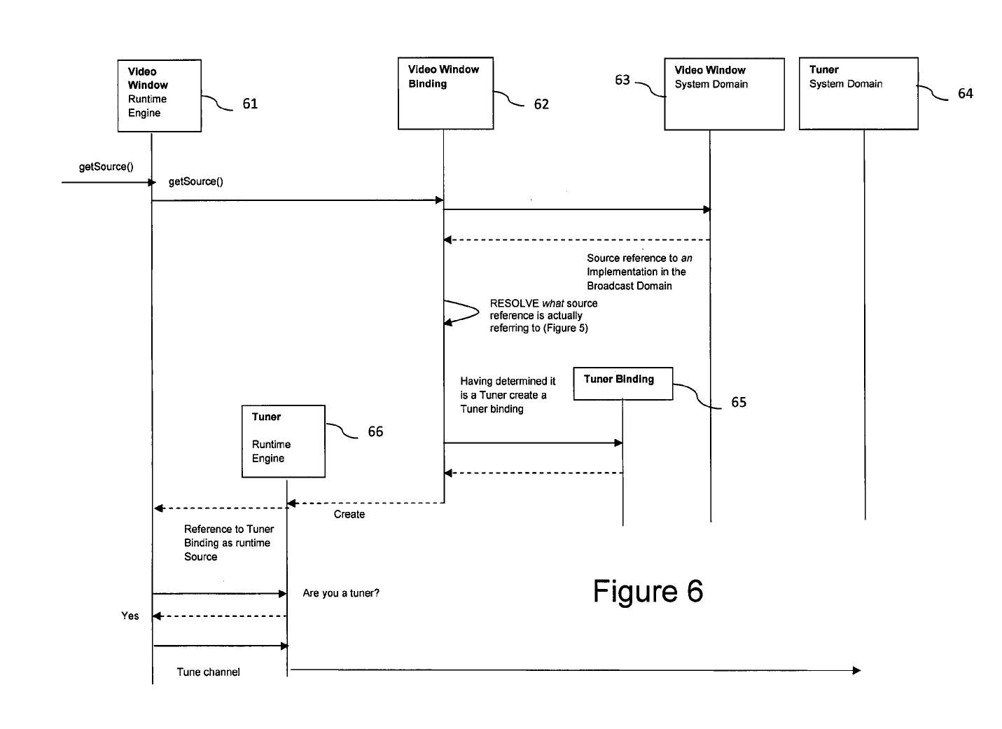

The invention provides a mechanism for selecting the most-specific Binding that is applicable to the dynamic, run-time type of the object. This is provided as part of the Run-time Binding Support Framework Library 27, and is illustrated in more detail in FIG. 5. A UML sequence diagram illustrating for the example mentioned above, the interaction of the VideoWindow object with this mechanism is illustrated in FIG. 6.

The example implementation of the mechanism illustrated in FIG. 5 is a dual data structure comprising on the one hand a list of run-time type identifiers 51, and on the other a set of inheritance tree structures 52 that reflect the inheritance hierarchies existing between the interfaces for which bindings exist. Each node in a tree represents a type in the list 51, and carries a reference to the binding 53 for that type. These dual data structures 51 and 52 therefore form a Binding Registry mapping each system facing side type to its respective binding 53.

In this example, the mechanism employs a C++ language feature known as RTTI (Run-Time Type Information) to gain access to the appropriate tree and location. For example, the TypeID of the actual Source object, namely Tuner or IP Source, may be requested by the VideoWindow Binding if the VideoWindow requests an operation for which the identity of the Source needs to be known, for example a Source Tuner operation.

With reference to FIG. 6, consider a Video Window object 61 in a first run-time user-facing environment, connected by means of a VideoWindow binding 62 to a corresponding Video Window object 63 in a second ‘system’ run-time environment. The Video Window object 63 exists to maintain correspondence between the two parallel run-time environments. As shown in FIG. 6, in this example, the VideoWindow 63 has access to a Tuner object 64. The Tuner object 64 is not visible to the VideoWindow 61 due to the different levels of abstraction provided in between.

If a GetSource( ) method is performed on the VideoWindow 61, then the request is passed via Video Window Binding 62 to system Video Window 63, that because of the implementation of the GetSource method returns the static type Source to the requesting function of the VideoWindow Binding. The VideoWindow binding is subsequently able using the RTTI to determine the dynamic type of the actual Source Implementation for the Video Window 63, in this case an actual Tuner implementation 64 such as the System Tuner shown in FIG. 4.

Lookup table 51 is then used to look up the tree 52 corresponding to the static type of the object, in this case Source, and the retrieved tree is traversed in a predetermined order, such as a leftmost depth-first order, to search for the most-specific (i.e. deepest in the tree) node compatible with the dynamic type of the actual object. The issue of compatibility refers to matching the dynamic type of the object with the most appropriate Binding. Thus, each node in the tree provides logic that is operable to determine whether the dynamic type of an object referenced by a pointer to its parent type is run-time-compatible with the type it represents.

In the example shown in FIG. 5, the Tuner dynamic type is found to be compatible with the Source class, as well as with the specialised Tuner class by means of a C++ language feature known as dynamic-casting, essentially determining whether a base class pointer such as Source can be downcast to a derived class, such as Tuner.

The Tuner binding 65 referenced by the Tuner node is then created to wrap the value for exposure to the target, as illustrated by the numbered process arrows in FIG. 5. Once the dynamic type has been identified a corresponding Tuner object 66 can then be created in the user-facing run-time and synchronised with the Video Window.

In alternative implementations, the tree-traversal step can be avoided with the addition of an optimisation to the look up table 51. Once the appropriate Binding has been identified for a dynamic type, the look-up table can be updated to provide an additional entry which maps directly from the dynamic type (e.g. SystemTuner) to the applicable Binding (TunerBinding). In such implementations the look-up operation to the registry should by default perform the look-up operation via the dynamic type in the first instance, and if this is not available subsequently by the static type. This allows the tree traversal step to be avoided for all but the first lookup for the static type.

It should be noted that although the example above had been described in simple terms to aid understanding, and has only a very shallow inheritance hierarchy, the procedure is readily applicable to inheritance relationships of arbitrary depth. In addition, the process is in no way dependent on the specific type hierarchy described in this example, but is in fact a general solution to the described problem.

Although the example above considers the use of a set top box as the device in which the parallel run-time environments exist, and an implementation using C++ and JavaScript, it will be appreciated that the invention may be implemented in any suitable computer environment or device, such as a computer, or computer network, mobile computing device, phone, and indeed any electronic device making use of parallel run-time heterogeneous environments, as well as in any suitable computer language.

Additionally, an implementation of the invention in a broadcasting scenario has been described, the utility of the invention is not limited to such but includes any scenario involving an object oriented computer environment, consisting of multiple run-time environments each potentially based on a different programming languages.

1. A computer implemented method for providing run-time bindings between multiple heterogeneous run-time environments in a computing device in which software objects having polymorphic types are employed, the bindings providing code for manipulating the attributes of, and invoking the methods of, software objects according to their dynamic type in one run-time environment from another, the method comprising:
a) providing a registry of class types for software objects, in which each class type is linked to a hierarchy of bindings rooted at the binding for that class type with descendent bindings in the hierarchy relating to more specific sub-classes;
b) receiving at run-time a pointer to an object, and looking-up the received static type of that pointer in the registry to determine the location in the hierarchy of bindings at which to make an initial query for the most specific sub-class compatible with the dynamic type of the object;
c) beginning at the location in the hierarchy of bindings determined in step b), identifying the most specific sub-class by determining which specific sub-class is compatible with the dynamic type of the object;
d) selecting a run-time binding based on the most specific sub-class identified in step c).

2. The method of claim 1, wherein in step c) determining whether a sub-class is compatible with the dynamic type of the object is achieved by attempting to downcast the object pointer to a pointer of the sub-class type.

3. The method of claim 1, wherein at run-time once a binding has been identified in step d) an entry is added to the registry linking the dynamic type with the identified run-time binding.

4. A computer implemented method of providing run-time bindings in a computer device, in which first software objects provided in a first run-time environment are to be bound at run-time to second software objects provided in a second run-time environment, and wherein at least the first software objects are polymorphic with respect to their run-time data types, the run-time bindings providing code for manipulating the attributes of, and invoking the methods of, software objects according to their dynamic type, the method comprising:
a) receiving definitions for the methods and attributes respectively exposed by the first and second software objects;
b) generating binding source code based on the received definitions and a rule base;
c) receiving mapping code defining, for a plurality of class types, a hierarchy of bindings rooted at the binding for a first class type with descendent bindings in the hierarchy relating to more specific sub-classes;
d) compiling the mapping code and binding source code to produce a run-time binding library and a run-time binding support registry;
wherein the run-time binding support registry lists for each object class type a hierarchy of bindings rooted at the binding for that class type with descendent bindings in the hierarchy relating to more specific sub-classes, and wherein the run-time binding support registry can be queried at run-time based on the received static type of an object pointer to determine the location in the hierarchy of bindings at which to make an initial query for the most specific sub-class compatible with the dynamic type of the object; and
at run-time, selecting a run-time binding based on the most specific sub-class derived class identified as compatible with the dynamic type of the object.

5. A computer program product having code stored thereon which when executed by a computer causes the computer to carry out the method of any of claims 1 to 4.
